(19) United States
(12) Patent Application Publication
(10) Pub. No.: US 2019/0390676 A1
(43) Pub. Date: Dec. 26, 2019

(54) CENTRIFUGAL BLOWER DEVICE

(71) Applicants: DENSO CORPORATION, Kariya-city (JP); SOKEN, INC., Nisshin-city (JP)

(72) Inventors: Fumiya ISHII, Kariya-city (JP); Shuzo ODA, Kariya-city (JP); Masanori YASUDA, Nisshin-city (JP)

(21) Appl. No.: 16/562,156

(22) Filed: Sep. 5, 2019

Related U.S. Application Data
(63) Continuation of application No. PCT/JP2018/006456, filed on Feb. 22, 2018.

(30) Foreign Application Priority Data
Mar. 29, 2017 (JP) 2017-065498

(51) Int. Cl. F04D 17/08; F04D 29/28; F04D 25/06

(52) U.S. Cl. CPC F04D 17/08; F04D 29/281; F05D 2240/50; F05D 2240/60; F04D 25/06

(57) ABSTRACT

A centrifugal blower device has a turbo fan unit and a casing. The casing includes a first casing member and a second casing member. One of the first casing member and the second casing member includes a first step portion having a first surface, a second step portion having a second surface, and a third step portion having a third surface. Each of the first surface, the second surface and the third surface forms a part of an outer surface of the one of the casing members and has a position different from one another in an axial direction. The second surface is located at a position closer than the first surface to the other one of the first casing member and the second casing member. The third surface is located at a position closer than the second surface to the other one of the casing members.

### CROSS REFERENCE TO RELATED APPLICATION

The present application is a continuation application of International Patent Application No. PCT/JP2018/006456 filed on Feb. 22, 2018, which designated U.S. and claims the benefit of priority from Japanese Patent Application No.2017-065498 filed on Mar. 29, 2017. The entire disclosures of all of the above applications are incorporated herein by reference.

### FIELD OF TECHNOLOGY

The present disclosure relates to a centrifugal blower device.

### BACKGROUND

A centrifugal blower device is known in the art. For example, one of the centrifugal blower devices includes a rotating shaft, a turbo fan rotated with the rotating shaft, and a casing for accommodating therein the turbo fan. The casing has a first casing member provided on one side of the turbo fan in an axial direction of the rotating shaft, and a second casing member provided on the other side of the turbo fan in the axial direction of the rotating shaft.

Each of the first casing member and the second casing member has a first step portion and a second step portion. The second step portion is provided at a position outside of the first step portion in a radial direction of the turbo fan. The first step portion has a first surface forming a part of an outer surface of the casing. The second step portion has a second surface forming another part of the outer surface of the casing. In one of the first casing member and the second casing member, the second surface is provided at a position of the other side of the first casing member and the second casing member, which is closer to the other side than the first surface.

There is a demand for further reducing a space for mounting the centrifugal blower device. It is necessary to reduce a thickness of the centrifugal blower device in an axial direction of a rotating shaft, in order to achieve a reduction of a mounting space.

### SUMMARY OF THE DISCLOSURE

It is an object of the present disclosure to provide a centrifugal blower device, according to which the thickness can be reduced in the axial direction of the rotating shaft.

According to one of features of the present disclosure, one of a first casing member and a second casing member of a blower device includes a first step portion having a first surface, a second step portion having a second surface, and a third step portion having a third surface,

wherein the first step portion, the second step portion and the third step portion are arranged in an order of the first step portion, the second step portion and the third step portion in a direction from an inside to an outside of a radial direction,

wherein each of the first surface, the second surface and the third surface forms a part of an outer surface of the one of the casing members and has a different position from one another in an axial direction,

wherein the second surface is located at a position closer than the first surface to the other one of the first casing member and the second casing member, and

wherein the third surface is located at a position closer than the second surface to the other one of the first casing member and the second casing member.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross-sectional view showing a vehicle passenger seat, in which a centrifugal blower device of a first embodiment is arranged.

FIG. 2 is a schematic perspective view showing the centrifugal blower device of the first embodiment.

FIG. 3 is a schematic cross-sectional view taken along a line III-III in FIG. 2.

FIG. 4 is a schematic perspective view showing the centrifugal blower device of FIG. 2, wherein a first casing member is removed.

FIG. 5 is a schematically enlarged view showing a left-hand half portion of FIG. 3.

FIG. 6 is a schematically enlarged view showing a portion of FIG. 5 including a first step portion of a first cover portion and a part of a shroud ring.

FIG. 7 is a schematically enlarged cross-sectional view showing a centrifugal blower device of a second embodiment.

FIG. 8 is a schematically enlarged cross-sectional view showing a centrifugal blower device of a third embodiment.

FIG. 9 is a schematic perspective view showing a centrifugal blower device of a further embodiment, wherein a first casing member is removed.

### DETAILED DESCRIPTION OF THE EMBODIMENTS

Embodiments for a centrifugal blower device will be explained hereinafter with reference to the drawings. The same reference numerals are given to the same or similar structures and/or portions in each of the drawings in order to avoid repeated explanation.

### First Embodiment

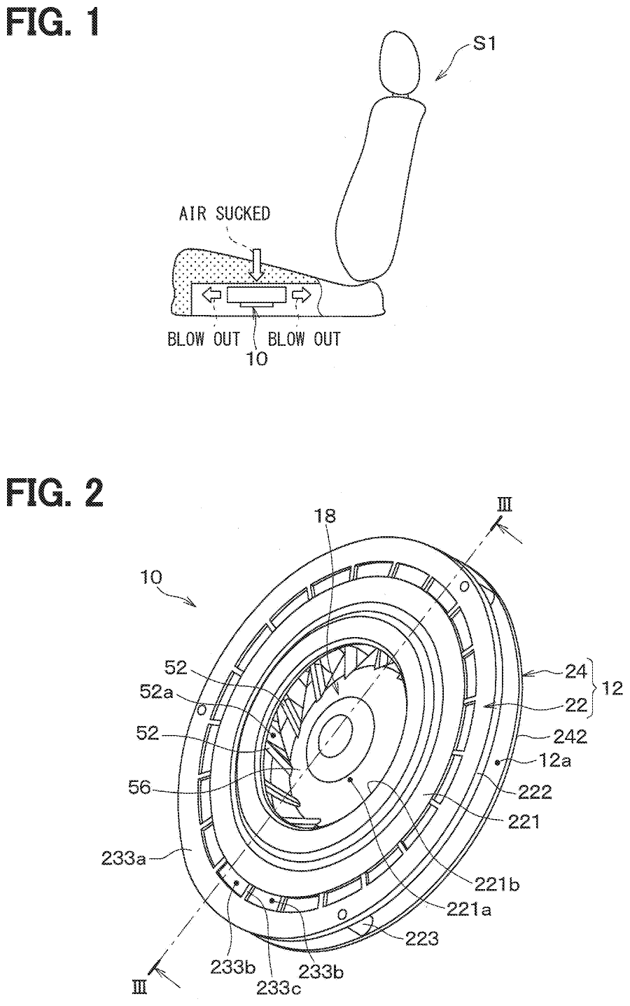

As shown in FIG. 1, a blower device 10 of the present embodiment is used for an air conditioning device of a vehicle passenger seat S1. The blower device 10 is arranged in an inside of the vehicle passenger seat S1, on which a passenger sits down. The blower device 10 draws air from a surface of the vehicle passenger seat S1 on a passenger side. The blower device 10 blows out the air in the inside of the vehicle passenger seat S1. The air blown out from the blower device 10 is discharged from a portion of the vehicle passenger seat S1 other than the surface of the passenger side.

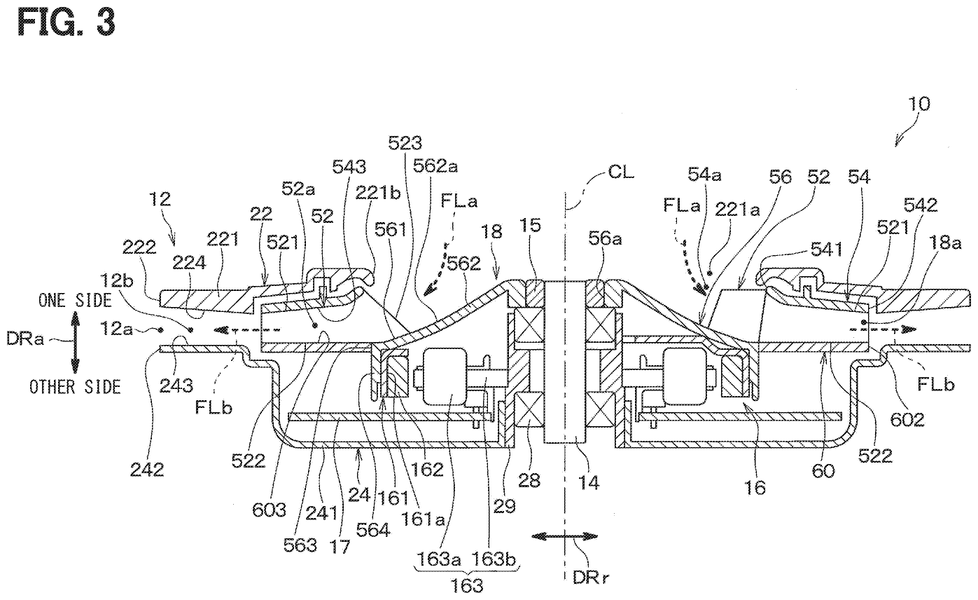

As shown in FIGS. 2 and 3, the blower device 10 is composed of a centrifugal blower device. More exactly, the blower device 10 is composed of a turbo-type blower. As shown in FIG. 3, the blower device 10 includes a casing 12, a rotating shaft 14, a shaft housing 15, an electric motor 16, an electronic circuit board 17, a turbo fan unit 18, bearings 28, a bearing housing 29 and so on. An arrow DRa in FIG. 3 shows a direction of a fan center axis. A fan center line CL coincides with a rotating axis of the rotating shaft 14. The direction of the fan center axis is also referred to as a fan axial direction of the rotating shaft. An arrow DRr in FIG. 3 shows a fan radial direction.

The casing 12 is a housing for the blower device 10. The casing 12 protects the electric motor 16, the electronic circuit board 17 and the turbo fan unit 18 from dust and blot of an outside of the blower device 10. For that purpose, the casing 12 accommodates therein the electric motor 16, the electronic circuit board 17 and the turbo fan unit 18. The casing 12 has a first casing member 22 and a second casing member 24.

The first casing member 22 is made of resin. The first casing member 22 is formed in an almost disc shape having a diameter larger than that of the turbo fan unit 18. The first casing member 22 has a first cover portion 221 and a first peripheral portion 222.

The first cover portion 221 is arranged on one side of the turbo fan unit 18 in the fan axial direction DRa. An air inlet opening 221a is formed on an inner peripheral side of the first cover portion 221, in such a way that the air inlet opening 221a penetrates the first cover portion 221 in the fan axial direction DRa. The air inlet opening 221a is a casing-side air suction port for sucking the air into an inside of the casing 12. The air is sucked into the turbo fan unit 18 via the air inlet opening 221a.

The first cover portion 221 has a bell-mouth portion 221b, which forms an outer periphery of the air inlet opening 221a. The bell-mouth portion 221b smoothly guides the air flowing from an outside of the blower device 10 into the air inlet opening 221a. The bell-mouth portion 221b is a casing-side inner peripheral end for forming the casing-side air suction port. The first peripheral portion 222 forms an outer periphery of the first casing member 22 around the fan center line CL.

As shown in FIG. 2, the first casing member 22 has multiple supporting pillars 223. Each of the supporting pillars 223 is arranged at an outside of the turbo fan unit 18 in the fan radial direction DRr. The first casing member 22 and the second casing member 24 are connected to each other in a condition that a forward end of each supporting pillar 223 is brought into contact with the second casing member 24.

The second casing member 24 is formed in an almost disc shape having a diameter almost equal to that of the first casing member 22. The second casing member 24 is made of the resin. The second casing member 24 may be made of metal, such as iron, stainless steel or the like.

As shown in FIG. 3, the second casing member 24 also functions as a motor housing for covering the electric motor 16 and the electronic circuit board 17. The second casing member 24 has a second cover portion 241 and a second peripheral portion 242.

The second cover portion 241 is arranged on the other side of the turbo fan unit 18 and the electric motor 16 in the fan axial direction DRa. The second cover portion 241 covers the other side of the turbo fan unit 18 and the electric motor 16. The second peripheral portion 242 forms an outer periphery of the second casing member 24 around the fan center line CL.

An air blow-out opening 12a is formed between the first peripheral portion 222 and the second peripheral portion 242, through which the air blown out from the turbo fan unit 18 is discharged.

The first cover portion 221 has a first opening-forming surface 224 at a position outside of multiple fan blades 52 in the fan radial direction DRr. The first opening-forming surface 224 is a part of the surface of the first cover portion 221 on the other side of the fan axial direction DRa. Therefore, the first opening-forming surface 224 is located on the other side of the first cover portion 221 in the fan axial direction DRa.

The second cover portion 241 has a second opening-forming surface 243 at a position outside of the multiple fan blades 52 in the fan radial direction DRr. The second opening-forming surface 243 is a part of the surface of the second cover portion 241 on the one side of the fan axial direction DRa. Therefore, the second opening-forming surface 243 is located on the one side of the second cover portion 241 in the fan axial direction DRa.

The first opening-forming surface 224 and the second opening-forming surface 243 form an air blow-out passage 12b between them, through which the air blown out from each blade passage 52a flows to the air blow-out opening 12a.

Each of the rotating shaft 14 and the shaft housing 15 is made of metal, such as, iron, stainless steel, brass or the like. The rotating shaft 14 is composed of a rod member. The rotating shaft 14 is inserted into the shaft housing 15 and each of inner races of the bearings 28 and fixed thereto. Each of outer races of the bearings 28 is press-inserted into the bearing housing 29 and fixed thereto. The bearing housing 29 is fixed to the second cover portion 241. The bearing housing 29 is made of metal, for example, such as aluminum alloy, brass, stainless steel or the like.

As above, the rotating shaft 14 and the shaft housing 15 are supported by the second cover portion 241 via the bearings 29. In other words, the rotating shaft 14 and the shaft housing 15 are rotatable around the fan center line CL with respect to the second cover portion 241.

In the inside of the casing 12, the shaft housing 15 is fitted into an inner peripheral hole 56a of a boss portion 56 of the turbo fan unit 18. Accordingly, the rotating shaft 14 and the shaft housing 15 are connected to the boss portion 56 of the turbo fan unit 18, so that the rotating shaft 14 and the shaft housing 15 are not rotatable with respect to the turbo fan unit 18. Namely, the rotating shaft 14 and the shaft housing 15 are integrally rotated with the turbo fan unit 18 around the fan center line CL.

The electric motor 16 is composed of a brushless DC motor of an outer-rotor type. The electric motor 16 includes a motor rotor 161, a rotor magnet 162 and a motor stator 163.

The motor rotor 161 is an outer rotor arranged at an outside of the motor stator 163 in the fan radial direction DRr. The motor rotor 161 is made of metal, such as steel sheets or the like. The motor rotor 161 is made by press forming of metal sheets.

The motor rotor 161 has a rotor cylindrical portion 161a. The rotor cylindrical portion 161a extends in a direction parallel to the fan axial direction DRa. The rotor cylindrical portion 161a is press-inserted into an inner peripheral side of an annular wall portion 564 of the turbo fan unit 18, as explained below. The motor rotor 161 is thereby fixed to the turbo fan unit 18.

The rotor magnet 162 is composed of a permanent magnet, for example, a rubber magnet including ferrite, neodymium or the like. The rotor magnet 162 is fixed to an inner peripheral surface of the rotor cylindrical portion 161a. Accordingly, the motor rotor 161 and the rotor magnet 162 are integrally rotated with the turbo fan unit 18 around the fan center line CL.

The motor stator 163 includes a stator coil 163a electrically connected to the electronic circuit board 17 and a stator core 163b. The motor stator 163 is arranged at a radial-inside position with a small gap with the rotor magnet 162. The motor stator 163 is fixed to the second cover portion 241 of the second casing member 24 via the bearing housing 29. As above, the electric motor 16 is supported by the second casing member 24 in the inside of the casing 12.

In the electric motor 16 having the above structure, flux change is generated in the stator core 163b by the stator coil 163a, when electric power is supplied to the stator coil 163a of the motor stator 163 from an outside power source. The flux change in the stator core 163b generates an attracting force for the rotor magnet 162. Therefore, the motor rotor 161 receives the attracting force for the rotor magnet 162 and thereby the motor rotor 161 is rotated around the fan center line CL. Accordingly, when the electric power is supplied to the electric motor 16, the turbo fan unit 18 fixed to the motor rotor 161 is rotated around the fan center line CL.

As shown in FIG. 3, the turbo fan unit 18 is an impeller applied to the blower device 10. The turbo fan unit 18 blows out the air when it is rotated around the fan center line CL in a predetermined fan rotational direction. In other words, when the turbo fan unit 18 is rotated around the fan center line CL, the air is drawn into the inside thereof from the one side of the fan axial direction DRa via the air inlet opening 221a, as indicated by an arrow FLa in FIG. 3. Then, the turbo fan unit 18 blows out the air drawn into the inside thereof to the outside of the turbo fan unit 18, as indicated by an arrow FLb in FIG. 3.

More exactly, the turbo fan unit 18 includes the multiple fan blades 52, a shroud ring 54, the boss portion 56 and an other-side side plate 60. Each of the multiple fan blades 52, the shroud ring 54, the boss portion 56 and the other-side side plate 60 is made of resin.

The multiple fan blades 52 are arranged around the fan center line CL. More exactly, the multiple fan blades 52 are arranged at intervals in a circumferential direction of the fan center line CL in such a manner that a space for air flow is respectively formed between the fan blades. As shown in FIG. 2, the multiple fan blades 52 form the blade passages 52a between the respective neighboring fan blades 52, so that the air flows through each of the blade passages 52a.

As shown in FIG. 3, each of the fan blades 52 has a one-side blade end 521, which is formed in the fan blade 52 on the one side of the fan axial direction DRa, and an other-side blade end 522, which is formed in the fan blade 52 on the other side of the fan axial direction DRa, that is, on the opposite side to the one side.

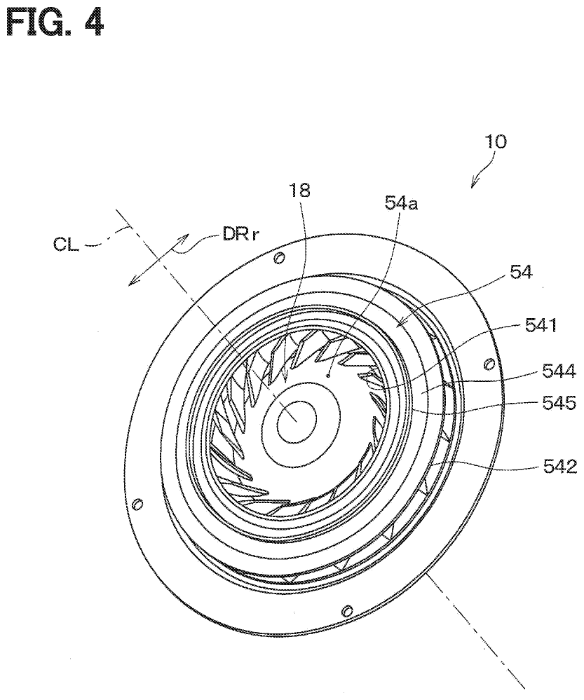

As shown in FIGS. 3 and 4, the shroud ring 54 is formed in a disc shape extending in the fan radial direction DRr. A fan-side air suction port 54a is formed at an inner peripheral side of the shroud ring 54. The air from the air inlet opening 221a of the casing 12 is sucked into the inside via the fan-side air suction port 54a, as indicated by the arrow FLa. The shroud ring 54 is formed in an annular shape.

The shroud ring 54 has a shroud-side inner peripheral end 541 and a shroud-side outer peripheral end 542. The shroud-side inner peripheral end 541 is an inner end portion of the shroud ring 54 in the fan radial direction DRr. More exactly, the shroud-side inner peripheral end 541 is a forward-end portion including an inner-side forward end of the shroud ring 54 in the fan radial direction DRr. The shroud-side inner peripheral end 541 forms the fan-side air suction port 54a. The shroud-side outer peripheral end 542 is an outer end portion of the shroud ring 54 in the fan radial direction DRr.

As shown in FIG. 3, the shroud ring 54 is arranged at the one side of each fan blade 52 in the fan axial direction DRa, that is, on a side of the air inlet opening 221a. The shroud ring 54 is connected to each of the fan blades 52. In other words, the shroud ring 54 is connected to the one-side blade end 521 of each fan blade 52.

The boss portion 56 is connected to the rotating shaft 14, which is rotatable around the fan center line CL, via the shaft housing 15. An outer peripheral portion 561 of the boss portion 56 is connected to each of the multiple fan blades 52 at a position opposite to the shroud ring 54.

The boss portion 56 has a boss-side guide portion 562. The boss-side guide portion 562 has a boss-side guide surface 562a on the one side of the boss-side guide portion 562 in the fan axial direction DRa. The boss-side guide surface 562a has a surface shape, a surface point of which is displaced from its inside to its outside in the fan radial direction DRr when the surface point is moved from the one side to the other side in the fan axial direction DRa. The boss-side guide surface 562a guides the air flow in an inside of the turbo fan unit 18. The boss-side guide surface 562a guides the air flow sucked from the air inlet opening 221a in the fan axial direction DRa in such a way that the air flow is directed to the outside in the fan radial direction DRr.

In addition, the boss portion 56 has a boss-side outer peripheral end 563 and the annular wall portion 564 of an annular shape. The boss-side outer peripheral end 563 is an end portion of the boss portion 56, which is located at an outside of the boss portion 56 in the fan radial direction DRr. More exactly, the boss-side outer peripheral end 563 is the end portion for forming the outer periphery of the boss-side guide portion 562. The boss-side outer peripheral end 563 is located at a position inside of the shroud-side inner peripheral end 541 in the fan radial direction DRr.

The annular wall portion 564 is a cylindrical rib extending from the boss-side outer peripheral end 563 to the other side of the fan axial direction DRa. The motor rotor 161 is fitted into an inside of the annular wall portion 564. Namely, the annular wall portion 564 has function as a rotor accommodating portion for accommodating the motor rotor 161. When the annular wall portion 564 is fixed to the motor rotor 161, the boss portion 56 is fixed to the motor rotor 161.

The other-side side plate 60 is located at the other side of each fan blade 52 in the fan axial direction DRa. The other-side side plate 60 is connected to each of the multiple fan blades 52. In other words, the other-side side plate 60 is connected to the other-side blade end 522 of each fan blade 52. The other-side side plate 60 is connected to the outer peripheral end of the boss portion 56 in the fan radial direction DRr. The other-side side plate 60 has a shape extending in the fan radial direction DRr in a disc shape.

The shroud ring 54 and the other-side side plate 60 are connected to each of the fan blades 52. According to such a structure, the turbo fan unit 18 forms a closed fan. The closed fan is a turbo fan, in which both axial ends of each blade passage 52a formed between the respective fan blades 52 are covered by the shroud ring 54 and the other-side side plate 60 in the fan axial direction DRa.

Therefore, the shroud ring 54 has a ring-side guide surface 543, which faces the blade passages 52a and guides the air flow in the blade passages 52a. In addition, the other-side side plate 60 has a plate-side guide surface 603, which faces the blade passages 52a and guides the air flow in the blade passages 52a.

The plate-side guide surface 603 is opposed to the ring-side guide surface 543 across the blade passages 52a and arranged at a position outside of the boss-side guide surface 562a in the fan radial direction DRr. The plate-side guide surface 603 has a function for smoothly guiding the air flow flowing from the boss-side guide surface 562a to a fan-side air blow-out opening 18a.

The other-side side plate 60 has a plate-side outer peripheral end 602. The plate-side outer peripheral end 602 is a portion of the other-side side plate 60 at an outside thereof in the fan radial direction DRr.

The plate-side outer peripheral end 602 and the shroud-side outer peripheral end 542 are separately arranged from each other in the fan axial direction DRa. The plate-side outer peripheral end 602 and the shroud-side outer peripheral end 542 form the fan-side air blow-out opening 18a between the plate-side outer peripheral end 602 and the shroud-side outer peripheral end 542, wherein the air passing through the blade passages 52a is blown out from the fan-side air blow-out opening 18a.

As shown in FIG. 3, each of the fan blades 52 has a front-side blade edge 523. The front-side blade edge 523 is an end portion of the fan blade 52, which is formed at an upstream side of the air flow flowing along arrows FLa and FLb, that is, at the upstream side in a direction of a main air flow. The main air flow is the air flow flowing in the blade passages 52a after passing through the fan-side air suction port 54a. The front-side blade edge 523 is protruded from the shroud-side inner peripheral end 541 to the inside of the turbo fan unit 18 in the fan radial direction DRr. In other words, the front-side blade edge 523 extends from the shroud-side inner peripheral end 541 to the inside of the turbo fan unit 18 in the fan radial direction DRr. The front-side blade edge 523 is connected to the outer peripheral portion 561 of the boss portion 56.

As shown in FIG. 3, the turbo fan unit 18 having the above structure is rotated together with the motor rotor 161 in a fan rotating direction DRf. Then, the fan blades 52 of the turbo fan unit 18 give quantity of motion to the air. The turbo fan unit 18 thereby blows out the air from the fan-side air blow-out opening 18a, which is opened at an outer periphery of the turbo fan unit 18, to a radial outside thereof. The air sucked from the fan-side air suction port 54a and pushed out by the fan blades 52, that is, the air blown out from the fan-side air blow-out opening 18a, is discharged to the outside of the blower device 10 via the air blow-out opening 12a formed in the casing 12.

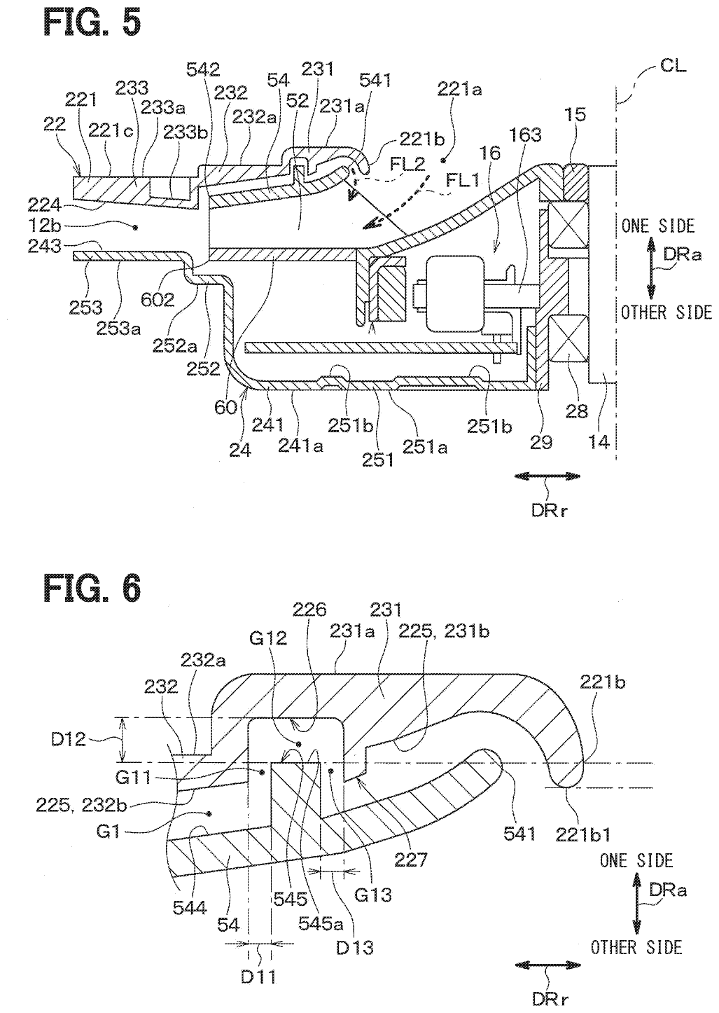

As shown in FIG. 5, the first cover portion 221 of the first casing member 22 has a first step portion 231, a second step portion 232 and a third step portion 233. The first step portion 231, the second step portion 232 and the third step portion 233 are arranged in an order of the first step portion 231, the second step portion 232 and the third step portion 233 in a direction from the inside to the outside of the fan radial direction DRr.

The first step portion 231 has a first surface 231a. The second step portion 232 has a second surface 232a. The third step portion 233 has a third surface 233a. Each of the first surface 231a, the second surface 232a and the third surface 233a forms a part of an outer surface 221c of the first cover portion 221. The outer surface 221c of the first cover portion 221 is a surface of the first cover portion 221 on the one side of the fan axial direction DRa.

Each of the first surface 231a, the second surface 232a and the third surface 233a has a position different from one another in the fan axial direction DRa. More exactly, the second surface 232a is located at the position, which is closer to the other side of the fan axial direction DRa than the first surface 231a, that is, at the position closer to the second cover portion 241. The third surface 233a is located at the position, which is closer to the other side of the fan axial direction DRa than the second surface 232a, that is, at the position closer to the second cover portion 241.

The first step portion 231 is formed in the inner peripheral portion of the first cover portion 221, which includes the bell-mouth portion 221b. The first step portion 231 is opposed to the shroud-side inner peripheral end 541. The second step portion 232 is formed in the first cover portion 221 at a position, at which the second step portion 232 is opposed to the shroud-side outer peripheral end 542 in the fan axial direction DRa. The third step portion 233 is formed in the first cover portion 221 at a position, at which the first opening-forming surface 224 is formed.

As above, the first casing member 22 has the first step portion 231, the second step portion 232 and the third step portion 233. Therefore, it is possible to reduce a thickness of the casing 12 in the fan axial direction DRa in an outer area of the casing 12 of the fan radial direction DRr, when compared with a case in which the first casing member 22 has only two step portions.

As shown in FIG. 2, the third surface 233a has multiple recessed portions 233b. Each of the recessed portions 233b is arranged in the circumferential direction around the rotating shaft 14 at an interval. As a result, in the multiple recessed portions 233b, a boundary portion between neighboring recessed portions 233b is formed as a projected portion 233c. Each of the projected portions 233c straightly extends in the fan radial direction. A bottom surface of each recessed portion 233b is located at a position, which is closer to the other side of the fan axial direction DRa than any other portion of the third surface 233a except for the recessed portion 233b.

As above, the third surface 233a preferably has the multiple recessed portions 233b. According to such a structure, it is possible to make the first casing member 22 lighter in its weight than a case in which the third surface 233a does not have the recessed portions 233b.

As shown in FIG. 5, the second cover portion 241 of the second casing member 24 has a first step portion 251, a second step portion 252 and a third step portion 253. The first step portion 251, the second step portion 252 and the third step portion 253 are arranged in an order of the first step portion 251, the second step portion 252 and the third step portion 253 in the direction from the inside to the outside of the fan radial direction DRr.

The first step portion 251 has a first surface 251a. The second step portion 252 has a second surface 252a. The third step portion 253 has a third surface 253a. Each of the first surface 251a, the second surface 252a and the third surface 253a forms a part of an outer surface 241a of the second cover portion 241. The outer surface 241a of the second cover portion 241 is a surface of the second cover portion 241 on the other side of the fan axial direction DRa.

Each of the first surface 251a, the second surface 252a and the third surface 253a has a position different from one another in the fan axial direction DRa. More exactly, the second surface 252a is located at the position, which is closer to the one side of the fan axial direction DRa than the first surface 251a, that is, at the position closer to the first cover portion 221. The third surface 253a is located at the position, which is closer to the one side of the fan axial direction DRa than the second surface 252a, that is, at the position closer to the first cover portion 221.

The first step portion 251 is formed in the second cover portion 241 at a position, at which the electric motor 16 is supported. In other words, the first step portion 251 is formed at the position of the second cover portion 241, at which the second cover portion 241 is opposed to the electric motor 16 in the fan axial direction DRa. A portion for supporting the electric motor 16 is a portion, at which the bearing housing 29 is fixed.

The second step portion 252 is formed in the second cover portion 241 at a position, at which the second cover portion 241 is opposed to the plate-side outer peripheral end 602 in the fan axial direction DRa. The third step portion 253 is formed in the second cover portion 241 at a position, at which the second opening-forming surface 243 is formed.

As above, the second casing member 24 has the first step portion 251, the second step portion 252 and the third step portion 253. Therefore, it is possible to reduce the thickness of the casing 12 in the fan axial direction DRa in the outer area of the casing 12 of the fan radial direction DRr, when compared with a case in which the second casing member 24 has only two step portions.

The first step portion 251 has multiple convex portions 251b protruded to the one side of the fan axial direction DRa. Each of the convex portions 251b extends in a curved line. More exactly, each of the convex portions 251b extends in the circumferential direction around the rotating shaft 14.

According to the above structure, in which the multiple convex portions 251b of the curved line are formed in the first step portion 251 of the second cover portion 241, it is possible to increase strength of the first step portion 251. In addition, the thickness of the casing 12 can be made smaller, when compared with a case in which the first step portion 251 of the second cover portion 241 has convex portions protruded to the other side of the fan axial direction DRa.

Each of the convex portions 251b may extend in a radial fashion. The number of the convex portion 251b is not limited to the multiple number. One convex portion may be formed.

Next, detailed structures for a part of the first step portion 231 of the first cover portion 221 and a part of the shroud ring 54 will be explained.

As shown in FIG. 6, the first cover portion 221 has a cover-side opposing surface 225 opposing to the shroud ring 54. The shroud ring 54 has a shroud-side opposing surface 544 opposing to the first cover portion 221. The cover-side opposing surface 225 and the shroud-side opposing surface 544 form a gap G1 between them.

The cover-side opposing surface 225 includes a gap forming surface 231b of the first step portion 231 and a gap forming surface 232b of the second step portion 232. The gap forming surface 231b of the first step portion 231 is a surface of the first step portion 231, which forms the gap G1. The gap forming surface 231b of the first step portion 231 is the surface of the first step portion 231, which is located on the other side of the fan axial direction DRa. The gap forming surface 232b of the second step portion 232 is a surface of the second step portion 232, which forms the gap G1. The gap forming surface 232b of the second step portion 232 is the surface of the second step portion 232, which is located on the other side of the fan axial direction DRa.

The gap forming surface 231b of the first step portion 231 has a cover-side recessed portion 226. The cover-side recessed portion 226 is formed in an annular shape in the circumferential direction around a center position, which corresponds to the position of the fan center line CL. The gap forming surface 231b of the first step portion 231 has a cover-side projecting portion 227. The cover-side projecting portion 227 is located at a position next to the cover-side recessed portion 226 and at an inside position of the cover-side recessed portion 226 in the fan radial direction DRr. In the present embodiment, the gap forming surface 231b of the first step portion 231 forms a one-side surface, which forms a gap between the first step portion of the first casing member and the shroud ring.

The shroud-side opposing surface 544 has a shroud-side projecting portion 545. The shroud-side projecting portion 545 is provided at the shroud-side opposing surface 544 in such an area, in which the shroud-side opposing surface 544 is opposed to the cover-side recessed portion 226 in the fan axial direction DRa. In the present embodiment, the shroud-side opposing surface 544 forms an other-side surface, which forms the gap between the first step portion of the first casing member and the shroud ring.

As shown in FIG. 4, the shroud-side projecting portion 545 is arranged in the circumferential direction around the fan center line CL. Therefore, the shroud-side projecting portion 545 is formed entirely in the circumferential direction of an area of the shroud-side opposing surface 544, which is opposing to the cover-side recessed portion 226.

As shown in FIG. 6, the shroud-side projecting portion 545 is arranged in an inside of the cover-side recessed portion 226. In this condition, the gap G1 is formed between the first cover portion 221 and the shroud ring 54. The gap G1 includes a first radial gap G11, an axial gap G12 and a second radial gap G13.

The first radial gap G11 is formed at an outside of the shroud-side projecting portion 545 in the fan radial direction DRr and between the shroud-side projecting portion 545 and the cover-side recessed portion 226 in the fan radial direction DRr. Therefore, the first radial gap G11 is a radial-direction gap formed between the first step portion 231 and the shroud ring 54 in the fan radial direction DRr.

The axial gap G12 is formed between the shroud-side projecting portion 545 and the cover-side recessed portion 226 in the fan axial direction DRa. Namely, the axial gap G12 is formed between the first step portion 231 and the shroud ring 54 in the fan axial direction DRa. The axial gap G12 is located at an inside of the first radial gap G11 in the fan radial direction DRr.

The second radial gap G13 is formed at an inside of the shroud-side projecting portion 545 in the fan radial direction DRr and between the shroud-side projecting portion 545 and the cover-side recessed portion 226 in the fan radial direction DRr. Accordingly, the second radial gap G13 is formed between the first step portion 231 and the shroud ring 54 in the fan radial direction DRr.

The first radial gap G11, the axial gap G12 and the second radial gap G13 are connected to one another in an order of the first radial gap G11, the axial gap G12 and the second radial gap G13 in a direction from the outside to the inside of the fan radial direction DRr.

A minimum gap dimension D11 of the first radial gap G11 is smaller than a minimum gap dimension D12 of the axial gap G12. The minimum gap dimension D11 of the first radial gap G11 is a shortest distance in the first radial gap G11 between the shroud ring 54 and the first step portion 231. The minimum gap dimension D12 of the axial gap G12 is a shortest distance in the axial gap G12 between the shroud ring 54 and the first step portion 231.

In a similar manner, a minimum gap dimension D13 of the second radial gap G13 is smaller than the minimum gap dimension D12 of the axial gap G12. The minimum gap dimension D13 of the second radial gap G13 is a shortest distance in the second radial gap G13 between the shroud ring 54 and the first step portion 231.

In the present embodiment, the first radial gap G11, the second radial gap G13 and the axial gap G12 form a labyrinth sealing structure. According to this structure, it is possible to make the pressure loss larger, which is generated when the air flows through the gap G1. Therefore, it is possible to make smaller an amount of a reverse flow FL2 indicated in FIG. 5. As a result, the noise, which may be generated when the main flow FL1 and the reverse flow FL2 join together, can be reduced.

The reverse flow FL2 is an air flow flowing in the gap G1 in a direction opposite to that of the main flow FL1 flowing through the blade passages 52a. The main flow FL1 is the air flow, which is generated by the turbo fan unit 18 and flows in the direction from the inside to the outside of the fan radial direction DRr.

In addition, according to the present embodiment, the first radial gap G11, the second radial gap G13 and the axial gap G12, which form the labyrinth sealing structure, is formed by the first step portion 231 of the first casing member 22. According to this structure, the shape of the first casing member 22 can be so made to have the first step portion 231, the second step portion 232 and the third step portion 233. It is possible to reduce the thickness of the first casing member 22 in the fan axial direction DRa in the second step portion 232 and the third step portion 233 of the first casing member 22.

Now, such a comparison case is considered herein, according to which the labyrinth sealing structure is formed between the second step portion 232 of the first casing member 22 and the shroud ring 54, like the present embodiment. In this case, however, the position of the second surface 232a of the second step portion 232 may be located at the same position to that of the first surface 231a of the first step portion 231, or at a position away from the first surface 231a to the one side of the fan axial direction DRa. Then, it becomes difficult to distinguish the second step portion 232 from the first step portion. In other words, it becomes impossible to form the three step portions 231, 232 and 233.

In addition, according to the present embodiment, a top portion 545a of the shroud-side projecting portion 545 is located at a position closer to the one side of the fan axial direction DRa than an other-side end 221b1 of the bell-mouth portion 221b, which is located at a position closest to the other side of the fan axial direction DRa. According to this structure, it is possible to obtain a higher labyrinth sealing effect.

### Second Embodiment

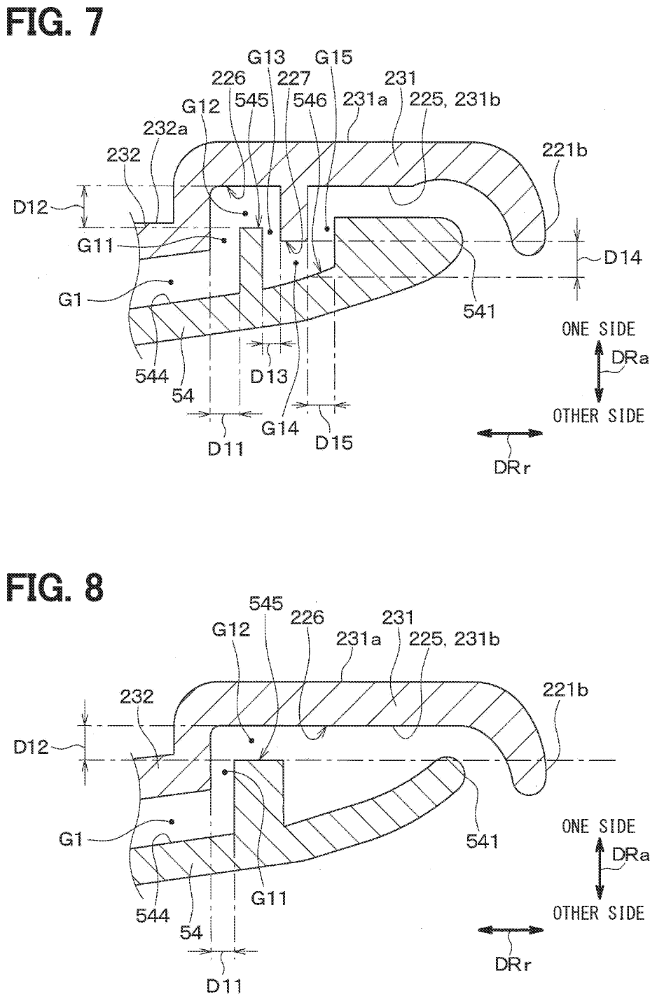

As shown in FIG. 7, the present embodiment differs from the first embodiment in that the gap G1 includes a second axial gap G14 and a third radial gap G15 in addition to the first radial gap G11, the second radial gap G13 and a first axial gap G12. The first axial gap G12 corresponds to the axial gap G12 of the first embodiment.

The shroud-side opposing surface 544 has a shroud-side recessed portion 546 at a position neighboring to the shroud-side projecting portion 545 and at a position inside of the shroud-side projecting portion 545 in the fan radial direction DRr. The shroud-side recessed portion 546 is formed in an annular shape in the circumferential direction around the rotating shaft 14. The cover-side projecting portion 227 is arranged in an inside of the shroud-side recessed portion 546.

The second axial gap G14 is formed between the cover-side projecting portion 227 and the shroud-side recessed portion 546 in the fan axial direction DRa. The second axial gap G14 is located at a position inside of the second radial gap G13 in the fan radial direction DRr.

The third radial gap G15 is formed at a position inside of the cover-side projecting portion 227 in the fan radial direction DRr and between the cover-side projecting portion 227 and the shroud-side recessed portion 546 in the fan radial direction DRr. The third radial gap G15 is located at a position inside of the second axial gap G14 in the fan radial direction DRr.

A minimum gap dimension D15 of the third radial gap G15 is smaller than the minimum gap dimension D12 of the first axial gap G12 and a minimum gap dimension D14 of the second axial gap G14. The minimum gap dimension D15 of the third radial gap G15 is a shortest distance in the third radial gap G15 between the shroud ring 54 and the first step portion 231. The minimum gap dimension D14 of the second axial gap G14 is a shortest distance in the second axial gap G14 between the shroud ring 54 and the first step portion 231.

The minimum gap dimension D11 of the first radial gap G11 is smaller than the minimum gap dimension D14 of the second axial gap G14. In a similar manner, the minimum gap dimension D13 of the second radial gap G13 is smaller than the minimum gap dimension D14 of the second axial gap G14.

In the present embodiment, the first radial gap G11, the second radial gap G13, the first axial gap G12, the second axial gap G14 and the third radial gap G15 form the labyrinth sealing structure. According to this structure, it is possible to further reduce the flow amount of the reverse flow FL2 when compared with a case in which the second axial gap G14 and the third radial gap G15 are not provided.

In the present embodiment, in the similar manner to the first embodiment, the labyrinth sealing structure is formed by the first step portion 231 of the first casing member 22. According to this structure, it is possible to make the shape of the first casing member 22 to have the first step portion 231, the second step portion 232 and the third step portion 233.

### Third Embodiment

As shown in FIG. 8, the present embodiment differs from the first embodiment in that the gap G1 has only the first radial gap G11, among the first radial gap G11 and the second radial gap G13.

In the present embodiment, the gap forming surface 231b of the first step portion 231 does not have the cover-side projecting portion 227 of the first embodiment. Therefore, a width in the fan radial direction DRr of the cover-side recessed portion 226 of the present embodiment is larger than a width in the fan radial direction DRr of the cover-side recessed portion 226 of the first embodiment.

The radial gap G11 is formed at a position outside of the shroud-side projecting portion 545 in the fan radial direction DRr and between the shroud-side projecting portion 545 and the cover-side recessed portion 226 in the fan radial direction DRr. The radial gap G11 corresponds to the first radial gap G11 of the first embodiment.

As above, the radial gap G11 can be formed only at one side of the shroud-side projecting portion 545 in the fan radial direction.

### Further Embodiments

(1) The area of the first casing member 22 in the fan radial direction DRr, in which the second step portion 232 is formed, may differ from the area of the embodiment shown in FIG. 5. In a similar manner, the area of the second casing member 24 in the fan radial direction DRr, in which the second step portion 252 is formed, may differ from the area of the embodiment shown in FIG. 5.

(2) In each of the above embodiments, the first casing member 22 has the first step portion 231, the second step portion 232 and the third step portion 233. However, the first casing member 22 may have a further step portion. In a similar manner, the second casing member 24 has the first step portion 251, the second step portion 252 and the third step portion 253. However, the second casing member 24 may have a further step portion.

(3) In each of the above embodiments, each of the first casing member 22 and the second casing member 24 has the first step portion, the second step portion and the third step portion. However, either one of the first casing member 22 and the second casing member 24 may have the first step portion, the second step portion and the third step portion. In this case, the other of the first casing member 22 and the second casing member 24 may have or may not have the step portions. However, the other of the first casing member 22 and the second casing member 24 may preferably have the first step portion and the second step portion, in order to reduce the thickness of the blower device 10.

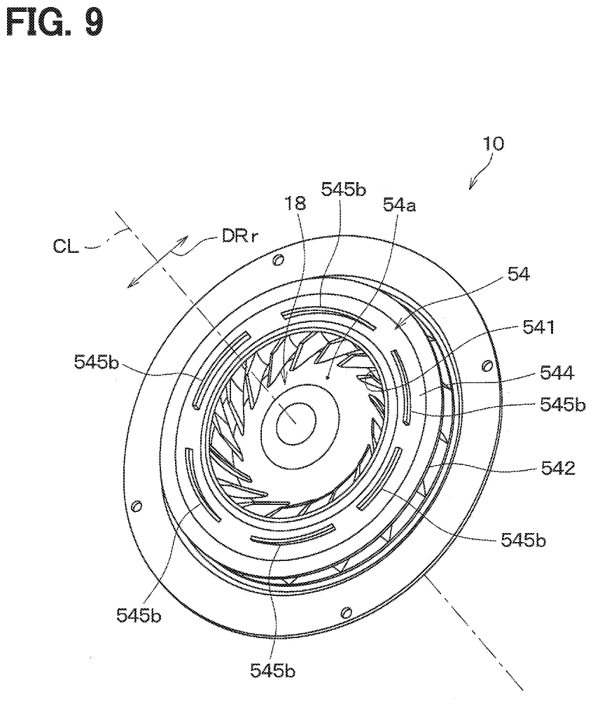

(4) In each of the above embodiments, the shroud-side projecting portion 545 is formed at the whole circumference of the annular area, at which the shroud-side opposing surface 544 is opposed to the cover-side recessed portion 266. However, as shown in FIG. 9, shroud-side projecting portions 545b may be formed at limited portions of the annular area, at which the shroud-side opposing surface 544 is opposed to the cover-side recessed portion 266. In other words, multiple shroud-side projecting portions 545b may be arranged in the circumferential direction at intervals.

(5) In each of the above embodiments, the gap forming surface 231b of the first step portion 231 has the cover-side recessed portion 226. The shroud-side opposing surface 544 has the shroud-side projecting portion 545. However, the gap forming surface 231b of the first step portion 231 may have recessed portions arranged in the circumferential direction. The shroud-side opposing surface 544 may have a projecting portion, which is formed at least in a part of an area in which the shroud-side opposing surface is opposing to the recessed portions.

(6) The present disclosure is not limited to the above embodiments but can be modified in various manners within a scope defined in the claims. The present disclosure includes various kinds of modified embodiments and such modifications included in equivalent areas. In addition, the above embodiments are not unrelated to one another and can be appropriately combined to one another except for such a case in which the combination is impossible in an obvious fashion. In addition, it is needless to say that the elements for forming the embodiments are not always necessary, unless the elements are explicitly disclosed as the necessary elements or it is considered that the elements are necessary in principle. In addition, in the above embodiments, when the values for the number, the numerical values, the quantity, the ranges or the like are referred to for the elements of the embodiments, the present disclosure is not limited to those specified values, except for a case in which those values are explicitly disclosed as necessary or the present disclosure should be limited to those specified values in principle. In addition, when the above embodiments refer to the material, the shape, the positional relationships and so on for the respective elements, the present disclosure is not limited to those material, the shapes, the positional relationships and so on, unless the present disclosure explicitly discloses or the present disclosure is limited in principle to those of the specified material, the shapes, the positional relationships and so on.

### Summary

According to a first point disclosed in a part or in an entire portion of each of the above embodiments, the centrifugal blower device includes the rotating shaft, the turbo fan unit and the casing. The turbo fan unit includes the multiple fan blades, the shroud ring and the other-side side plate. The casing includes the first casing member and the second casing member. The first casing member has the first opening-forming surface. The second casing member has the second opening-forming surface. The first opening-forming surface and the second opening-forming surface form the fan-side air blow-out opening. One of the casing members includes the first step portion having the first surface, the second step portion having the second surface and the third step portion having the third surface. The first step portion, the second step portion and the third step portion are arranged in the order of the first step portion, the second step portion and the third step portion in the direction from the inside to the outside of the radial direction. Each of the first step portion, the second step portion and the third step portion forms the part of the outer surface of one of the casing members and has the position different from one another in the axial direction. The second surface is located at the position closer to the other casing member than the first surface. The third surface is located at the position closer to the other casing member than the second surface.

In addition, according to a second point, the first casing member forms the above one of the casing members. Each of the first surface, the second surface and the third surface of the first casing member forms the part of the one-side surface of the first casing member in the axial direction. The second surface of the first casing member is located at the position closer to the second casing member than the first surface of the first casing member. The third surface of the first casing member is located at the position closer to the second casing member than the second surface of the first casing member.

As above, the first casing member has the shape, which has the first step portion, the second step portion and the third step portion.

In addition, according to a third point, the first casing member has a casing-side inner peripheral end for forming the casing-side air suction portion at the inside of the radial direction. The shroud ring has the shroud-side outer peripheral end at the outside of the radial direction. The first step portion of the first casing member is formed at the portion including the casing-side inner peripheral end of the first casing member. The second step portion of the first casing member is formed in the first casing member in such an area, in which the first casing member is opposed to the shroud-side outer peripheral end. The third step portion of the first casing member is formed in the portion of the first casing member, in which the first opening-forming surface is formed.

As above, the first step portion, the second step portion and the third step portion are formed in the first casing member.

In addition, according to a fourth point, the third surface of the first casing member has the multiple recessed portions, which are arranged in the circumferential direction around the rotating shaft. As above, it is preferable to form the recessed portions in the third surface. According to this structure, it is possible to make the first casing member lighter, when compared with the case in which the third surface does not have the recessed portions.

In addition, according to a fifth point, the first step portion of the first casing member and the shroud ring form the gap between them. The gap includes the radial gap formed between the first step portion and the shroud ring in the radial direction, and the axial gap formed between the first step portion and the shroud ring in the axial direction. The axial gap is located at the position inside of the radial gap in the radial direction. The minimum gap dimension of the radial gap is smaller than the minimum gap dimension of the axial gap.

According to the above structure, the radial gap and the axial gap form the labyrinth sealing structure. It is preferable to form the labyrinth sealing structure not between the second step portion of the first casing member and the shroud ring but between the first step portion of the first casing member and the shroud ring, in order to reduce the thickness of the first casing member.

In addition, according to a sixth point, the one-side surface of the first step portion of the first casing member or the one-side surface of the shroud ring has the recessed portion arranged in the circumferential form around the center of the rotating shaft. The other-side surface of the first step portion of the first casing member or the other-side surface of the shroud ring has the projecting portion, which is formed at least in the part of the area in which the other-side surface is opposed to the recessed portion. The projecting portion is located in the inside of the recessed portion. The radial gap is defined as the first radial gap. The first radial gap is formed at the outside of the projecting portion in the radial direction and between the projecting portion and the recessed portion in the radial direction. The axial gap is formed between the projecting portion and the recessed portion in the axial direction. The gap includes the second radial gap, which is formed at the inside of the projecting portion in the radial direction and between the projecting portion and the recessed portion in the radial direction. The minimum gap dimension of the second radial gap is smaller than the minimum gap dimension of the axial gap.

As above, the present disclosure may have the concrete structure.

In addition, according to a seventh point, the surface of the first step portion of the first casing member, which forms the gap, forms the one-side surface. The surface of the shroud ring, which forms the gap, forms the other-side surface. The top portion of the projecting portion is located at the position closer to the one side of the axial direction than the other-side end of the casing-side inner peripheral end, which is located at the most other side in the axial direction among the respective points of the first step portion.

The above positional relationship is preferable in order to obtain the higher labyrinth sealing effect.

In addition, according to an eighth point, the second casing member forms the one of the casing members. Each of the first surface, the second surface and the third surface of the second casing member forms a part of the other-side surface of the second casing member in the axial direction. The second surface of the second casing member is located at the position closer than the first surface of the second casing member to the first casing member. The third surface of the second casing member is closer than the second surface of the second casing member to the first casing member.

As above, the second casing member is so made to have the first step portion, the second step portion and the third step portion.

In addition, according to a ninth point, the centrifugal blower device has the electric motor for rotating the rotating shaft. The electric motor is supported by the second casing member in the inside of the casing. The other-side side plate has the plate-side outer peripheral end at the position outside of the radial direction. The first step portion of the second casing member is formed in the portion of the second casing member, at which the portion for supporting the electric motor is formed. The second step portion of the second casing member is formed in the portion of the second casing member, at which the second casing member is opposed to the plate-side outer peripheral end in the axial direction. The third step portion of the second casing member is formed in the portion of the second casing member, at which the second opening-forming surface is formed.

The second casing member has the first step portion, the second step portion and the third step portion as above.

In addition, according to a tenth point, the first step portion of the second casing member has the convex portion protruded to the one side of the axial direction. The convex portion linearly extends.

According to the above structure, since the convex portion linearly extending is formed, the strength of the first step portion can be increased. Furthermore, it is possible to reduce the thickness of the casing, when compared with the case in which the first step portion of the second casing member has the convex portion protruded to the other side of the axial direction.

What is claimed is:

1. A centrifugal blower device comprising:
a rotating shaft;
a turbo fan unit fixed to the rotating shaft and rotated together with the rotating shaft; and
a casing for accommodating therein the turbo fan unit,
wherein the turbo fan unit includes;
multiple fan blades arranged around the rotating shaft;
a shroud ring of an annular shape connected to a one-side blade end of each of the multiple fan blades, each of which is located on one side of an axial direction of the rotating shaft, wherein a fan-side air suction port through which air is sucked is formed in the shroud ring; and
an other-side side plate connected to each of other-side blade ends, each of which is located on the other side of the axial direction of the rotating shaft,
wherein the casing has a first casing member located on the one side of the axial direction with respect to the turbo fan unit, and a second casing member located on the other side of the axial direction with respect to the turbo fan unit,
wherein a casing-side air suction port is formed at an inside of the first casing member in a radial direction of the turbo fan unit, so that the air is sucked through the casing-side air suction port,
wherein a first opening-forming surface is formed on the other side of the first casing member in the axial direction, which is located at an outside of the multiple fan blades in the radial direction,
wherein a second opening-forming surface is formed on the one side of the second casing member in the axial direction, which is located at the outside of the multiple fan blades in the radial direction,
wherein an air blow-out passage is formed between the first opening-forming surface and the second opening-forming surface, through which the air blown out from blade passages respectively formed between neighboring fan blades flows,
wherein one of the first casing member and the second casing member includes a first step portion having a first surface, a second step portion having a second surface, and a third step portion having a third surface,
wherein the first step portion, the second step portion and the third step portion are arranged in an order of the first step portion, the second step portion and the third step portion in a direction from an inside to an outside of the radial direction,
wherein each of the first surface, the second surface and the third surface forms a part of an outer surface of the one of the casing members and has a different position from one another in the axial direction,
wherein the second surface is located at a position closer than the first surface to the other one of the first casing member and the second casing member, and
wherein the third surface is located at a position closer than the second surface to the other one of the first casing member and the second casing member.

2. The centrifugal blower device according to claim 1, wherein
the first casing member forms the one of the casing members,
each of the first surface, the second surface and the third surface belongs to the first casing member and forms a part of a surface of the first casing member on the one side of the axial direction,
the second surface of the first casing member is located at the position closer than the first surface of the first casing member to the second casing member, and
the third surface of the first casing member is located at the position closer than the second surface of the first casing member to the second casing member.

3. The centrifugal blower device according to claim 2, wherein
the first casing member has a casing-side inner peripheral end at its inside in the radial direction, wherein the casing-side inner peripheral end forms the casing-side air suction port,
the shroud ring has a shroud-side outer peripheral end at its outside in the radial direction,
the first step portion of the first casing member is formed in a portion of the first casing member, at which the casing-side inner peripheral end is formed,
the second step portion of the first casing member is formed in a portion of the first casing member, which is opposed to the shroud-side outer peripheral end in the axial direction, and
the third step portion of the first casing member is formed in a portion of the first casing member, at which the first opening-forming surface is formed.

4. The centrifugal blower device according to claim 3, wherein
the third surface of the first casing member has multiple recessed portions arranged in a circumferential direction around the rotating shaft.

5. The centrifugal blower device according to claim 3, wherein
the first step portion of the first casing member and the shroud ring form a gap between them,
the gap includes a radial gap formed between the first step portion and the shroud ring in the radial direction and an axial gap formed between the first step portion and the shroud ring in the axial direction,
the axial gap is located at a position inside of the radial direction with respect to the radial gap, and
a minimum gap dimension of the radial gap, which is a shortest distance between the first step portion and the shroud ring in the radial direction, is smaller than a minimum gap dimension of the axial gap, which is a shortest distance between the first step portion and the shroud ring in the axial direction.

6. The centrifugal blower device according to claim 5, wherein
a one-side surface, which is formed in one of the first step portion of the first casing member and the shroud ring and which forms the gap, has a recessed portion arranged in a circumferential direction around the rotating shaft,
an other-side surface, which is formed in the other one of the first step portion of the first casing member and the shroud ring and which forms the gap, has a projecting portion formed in at least a part of an area, at which the other-side surface is opposed to the recessed portion,
the projecting portion is arranged in an inside of the recessed portion,
the radial gap is defined as a first radial gap,
the first radial gap is formed between the projecting portion and the recessed portion in the radial direction at a position outside of the projecting portion in the radial direction,
the axial gap is formed between the projecting portion and the recessed portion in the axial direction,
the gap includes a second radial gap formed between the projecting portion and the recessed portion in the radial direction at a position inside of the projecting portion in the radial direction, and
a minimum gap dimension of the second radial gap, which is a shortest distance between the first step portion and the shroud ring in the radial direction, is smaller than the minimum gap dimension of the axial gap.

7. The centrifugal blower device according to claim 6, wherein
a surface of the first step portion of the first casing member, which forms the gap, forms the one-side surface,
a surface of the shroud ring, which forms the gap, forms the other-side surface, and
a top portion of the projecting portion is located at a position closer to the one side of the axial direction than an other-side end of the casing-side inner peripheral end, wherein the other-side end is located at a position closest to the other side of the axial direction.

8. The centrifugal blower device according to claim 1, wherein
the second casing member forms the one of the casing members,
each of the first surface, the second surface and the third surface belongs to the second casing member and forms a part of a surface of the second casing member on the other side of the axial direction,
the second surface of the second casing member is located at the position closer than the first surface of the second casing member to the first casing member, and
the third surface of the second casing member is located at the position closer than the second surface of the second casing member to the first casing member.

9. The centrifugal blower device according to claim 8, further comprising;
an electric motor for rotating the rotating shaft,
wherein the electric motor is supported by the second casing member in an inside of the casing,
the other-side side plate has a plate-side outer peripheral end at the outside of the radial direction,
the first step portion of the second casing member is formed in a portion of the second casing member, at which the electric motor is supported,
the second step portion of the second casing member is formed in a portion of the second casing member, at which the second casing member is opposed to the plate-side outer peripheral end in the axial direction, and
the third step portion of the second casing member is formed in a portion of the second casing member, in which the second opening-forming surface is formed.

10. The centrifugal blower device according to claim 9, wherein
the first step portion of the second casing member has a convex portion protruded in a direction to the one side of the axial direction, and
the convex portion linearly extends.

11. A centrifugal blower device comprising:
a rotating shaft;
a turbo fan unit fixed to the rotating shaft and rotated together with the rotating shaft; and
a casing for accommodating therein the turbo fan unit,
wherein the turbo fan unit includes;
multiple fan blades arranged around the rotating shaft;
a shroud ring of an annular shape connected to a first blade end of each of the multiple fan blades, each of which is located on one side of an axial direction of the rotating shaft, wherein a fan-side air suction port through which air is sucked is formed in the shroud ring, and wherein the shroud ring has a shroud-side outer peripheral end; and
a side plate connected to a second blade end of each of the multiple fan blades, each of which is located on the other side of the axial direction of the rotating shaft,
wherein the casing has a first casing member located on the one side of the axial direction with respect to the turbo fan unit and having a casing-side inner peripheral end at an inside of the radial direction, and a second casing member located on the other side of the axial direction with respect to the turbo fan unit,
wherein a casing-side air suction port is formed by the casing-side peripheral end at an inside of the first casing member in a radial direction of the turbo fan unit, so that the air is sucked through the casing-side air suction port,
wherein a first opening-forming surface is formed in the first casing member, which is located at an outside of the multiple fan blades in the radial direction, and a second opening-forming surface is formed in the second casing member, which is located at the outside of the multiple fan blades in the radial direction,
wherein an air blow-out passage is formed between the first opening-forming surface and the second opening-forming surface, through which the air blown out from blade passages respectively formed between neighboring fan blades flows,
wherein the first casing member includes a first step portion having a first surface, a second step portion having a second surface, and a third step portion having a third surface,
wherein the first step portion, the second step portion and the third step portion are arranged in an order of the first step portion, the second step portion and the third step portion in a direction from an inside to an outside of the radial direction,
wherein the first step portion of the first casing member is formed in a portion of the first casing member, at which the casing-side inner peripheral end is formed, the second step portion of the first casing member is formed in a portion of the first casing member, which is opposed to the shroud-side outer peripheral end in the axial direction, and the third step portion of the first casing member is formed in a portion of the first casing member, at which the first opening-forming surface is formed,
wherein each of the first surface, the second surface and the third surface forms a part of an outer surface of the first casing member and has a different position from one another in the axial direction,
wherein the second surface is located at a position closer than the first surface to the second casing member, and the third surface is located at a position closer than the second surface to the second casing member,
wherein the first step portion of the first casing member and the shroud ring form a gap between them, the gap includes a radial gap formed between the first step portion and the shroud ring in the radial direction and an axial gap formed between the first step portion and the shroud ring in the axial direction, and the axial gap is located at a position inside of the radial direction with respect to the radial gap, and
wherein a minimum gap dimension of the radial gap, which is a shortest distance between the first step portion and the shroud ring in the radial direction, is smaller than a minimum gap dimension of the axial gap, which is a shortest distance between the first step portion and the shroud ring in the axial direction.

12. The centrifugal blower device according to claim 11, wherein
the second casing member includes a first step portion having a first surface, a second step portion having a second surface, and a third step portion having a third surface,
the first step portion, the second step portion and the third step portion, each of which belongs to the second casing member, are arranged in an order of the first step portion, the second step portion and the third step portion in the direction from the inside to the outside of the radial direction,
the second surface of the second casing member is located at the position closer than the first surface of the second casing member to the first casing member, and
the third surface of the second casing member is located at the position closer than the second surface of the second casing member to the first casing member.
